(19) United States
(12) Patent Application Publication
(10) Pub. No.: US 2021/0197660 A1
(43) Pub. Date: Jul. 1, 2021

(54) FUEL ADAPTER STRUCTURE

(71) Applicant: HONDA MOTOR CO., LTD., Tokyo (JP)

(72) Inventors: Ryota Tsujimoto, Wako-shi (JP); Katsumi Hirano, Wako-shi (JP)

(21) Appl. No.: 17/114,562

(22) Filed: Dec. 8, 2020

(30) Foreign Application Priority Data
Dec. 26, 2019 (JP) 2019-237138

(51) Int. Cl. B60K 15/04

(52) U.S. Cl. CPC B60K 15/04; B60K 2015/0451

(57) ABSTRACT

A fuel adapter includes: an adapter main body, an outer panel-side seal part, and an inner panel-side seal part. The adapter main body is formed of a rigid plastic. The outer panel-side seal part and the inner panel-side seal part are formed of a flexible plastic to be elastically deformable. The inner panel-side seal part is capable of being subject to a deflection deformation that absorbs a variation of a relative position between the outer panel and the inner panel.

### CROSS-REFERENCE TO RELATED APPLICATION

Priority is claimed on Japanese Patent Application No. 2019-237138, filed on Dec. 26, 2019, the contents of which are incorporated herein by reference.

### BACKGROUND

### Field of the Invention

The present invention relates to a fuel adapter structure.

### Background

As a fuel adapter structure, such a structure is known in which a first ring groove part is formed on one end part of a fuel adapter formed in a cylindrical shape, and a second ring groove part is formed on another end part. According to this fuel adapter structure, the first ring groove part is fitted to a circumferential edge part of a first penetration hole of an outer panel, and thereby, the first penetration hole is sealed at the one end part of the fuel adapter. Further, the second ring groove part is fitted to a circumferential edge part of a second penetration hole of an inner panel, and thereby, the second penetration hole is sealed at the other end part of the fuel adapter (for example, refer to Japanese Unexamined Patent Application, First Publication No. 2005-335565).

Further, as another fuel adapter structure, such a structure is known in which a reinforcement flange and a lock claw are formed on one end part of a fuel adapter formed in a cylindrical shape, and a ring groove part is formed on another end part. According to this fuel adapter structure, the reinforcement flange and the lock claw are locked by a circumferential edge part of a first penetration hole of an outer panel, and thereby, the first penetration hole is sealed at the one end part of the fuel adapter. In this state, the fuel adapter is elastically deformed by being drawn to a rear inner panel side, the ring groove part is fitted to a circumferential edge part of a second penetration hole of a rear inner panel, and the second penetration hole is sealed at the other end part of the fuel adapter.

Thereby, for example, even when a relative position between the outer panel and the inner panel varies, it is possible to stretch and contract the fuel adapter and absorb the variation of the relative position. Thereby, it is possible to ensure that a space between the outer panel and a rear inner panel is in a sealed state (for example, refer to Japanese Patent No. 4088239).

### SUMMARY

However, in the fuel adapter structure of Japanese Unexamined Patent Application, First Publication No. 2005-335565, it is necessary to seal the space by fitting the first ring groove part to the circumferential edge part of the first penetration hole and fitting the second ring groove part to the circumferential edge part of the second penetration hole.

Further, in the fuel adapter structure of Japanese Patent No. 4088239, it is necessary to seal the space by elastically deforming the fuel adapter and fitting the ring groove part to the circumferential edge part of the second penetration hole after locking the reinforcement flange and the lock claw to the circumferential edge part of the first penetration hole.

Therefore, in the fuel adapter structure of Japanese Unexamined Patent Application, First Publication No. 2005-335565 and Japanese Patent No. 4088239, an assembly work of the fuel adapter becomes complicated, which prevents the assembly property of the fuel adapter from being enhanced.

An object of an aspect of the present invention is to provide a fuel adapter structure which is capable of absorbing the variation of a relative position between an outer panel and an inner panel without stretching and contracting a fuel adapter and which is furthermore capable of enhancing the assembly property.

A fuel adapter structure according to a first aspect of the present invention includes a fuel adapter that penetrates between an outer panel and an inner panel, wherein the fuel adapter includes: an adapter main body that is arranged between the outer panel and the inner panel and that is formed of a rigid plastic; an outer panel-side seal part that is formed of a flexible plastic to be elastically deformable on the adapter main body and that is in contact with the outer panel from an outside; and an inner panel-side seal part that is formed of a flexible plastic to be elastically deformable on the adapter main body and that is in contact with the inner panel, the adapter main body includes a lock part that is locked to the outer panel from an inside, and the inner panel-side seal part is capable of being subject to a deflection deformation that absorbs a variation of a relative position between the outer panel and the inner panel.

According to this configuration, the adapter main body is formed of a rigid plastic. Further, the outer panel-side seal part is in contact with the outer panel from the outside. Further, the lock part of the adapter main body is locked to the outer panel from the inside. Additionally, the variation of the relative position of the outer panel and the inner panel is absorbed by the deflection margin included in the inner panel-side seal part.

Accordingly, it is possible to deflect the inner panel-side seal part by pushing the fuel adapter from the outside of the outer panel. By deflecting and deforming the inner panel-side seal part, it is possible to absorb the variation of the relative position between the outer panel and the inner panel without stretching or contracting the fuel adapter. Accordingly, it is possible to press the outer panel-side seal part to the outer panel, and it is possible to press the inner panel-side seal part to the inner panel.

Thereby, it is possible to ensure that a space between the outer panel and the inner panel is in a sealed state by the fuel adapter only by pushing the fuel adapter, and it is possible to enhance the assembly property of the fuel adapter structure.

A second aspect of the present invention is the fuel adapter structure according to the first aspect described above, wherein the inner panel-side seal part may include: an outer seal part that is in contact with an outer surface of the inner panel; and an inner seal part that penetrates through the inner panel, and the inner seal part may include: a stopper portion that is arranged on an inside of the inner panel; a thick portion of which a thickness gradually increases from an outside of the inner panel toward the stopper portion; and an extraction portion that enables the deflection deformation by the thick portion.

According to this configuration, the inner seal part penetrates through the inner panel, and thereby, the inner seal part is pressed to an opening edge (circumferential edge) of a penetration hole of the inner panel. Accordingly, the variation in the opening edge caused by the variation of the relative position between the outer panel and the inner panel can be absorbed by the deflection deformation of the thick portion. Thereby, it is possible to press the thick portion to the opening edge in accordance with the variation of the opening edge, and it is possible to reliably seal the opening edge by the thick portion.

A third aspect of the present invention is the fuel adapter structure according to the second aspect described above, wherein the inner seal part may have an anti-deflection rib which is formed in an inside of the extraction portion to be directed in a direction that crosses obliquely with a deflection direction of the extraction portion so as to prevent the inner seal part from being deflected to an opposite side of the extraction portion.

According to this configuration, by forming the anti-deflection rib in the inside of the extraction portion, it is possible to prevent the thick portion from being deflected and deformed in a state where the thick portion of the inner seal part is in contact with the opening edge.

Further, the anti-deflection rib obliquely crosses relative to the deflection direction of the extraction portion. Accordingly, it is possible to deform the anti-deflection rib in accordance with the deflection deformation of the thick portion. Thereby, it is possible to suitably deflect and deform the thick portion without blocking the deflection deformation of the thick portion by the anti-deflection rib.

A fourth aspect of the present invention is the fuel adapter structure according to the second or third aspect described above, wherein the extraction portion may be an annular groove that opens at a front end of the thick portion and that is formed in an annular shape.

According to this configuration, the extraction portion is defined as the annular groove, and thereby, it is possible to deflect and deform the thick portion along an entire circumference of the opening edge of the penetration hole. Thereby, it is possible to absorb the variation of the relative position of the outer panel and the inner panel by the entire circumference of the opening edge of the penetration hole.

A fifth aspect of the present invention is the fuel adapter structure according to any of the second to fourth aspects described above, wherein the inner panel may include a penetration hole through which the inner seal part penetrates, an opening edge of the penetration hole may include a tapered part that is inclined toward an inside of the inner panel and toward the thick portion, and the thick portion may include an inclination surface that is inclined toward an inside of the inner panel and toward the tapered part.

According to this configuration, the tapered part of the opening edge and the inclination surface of the thick portion are inclined in a direction that crosses with each other. Accordingly, the inclination surface of the thick portion can be suitably adapted to the variation of the tapered part of the opening edge. That is, the variation of the tapered part of the opening edge can be suitably absorbed by the inclination surface of the thick portion.

Thereby, the inclination surface can reliably come into contact with the tapered part having the variation, and both reliable assembly of the fuel adapter and sealing of the opening edge (that is, the penetration hole) are enabled.

A sixth aspect of the present invention is the fuel adapter structure according to the fourth aspect described above, wherein the inner panel-side seal part may have a seal rip that is provided to extend from the annular groove of the thick portion so as to be in contact with a fuel supply piping.

According to this configuration, the seal rip is provided to extend from the annular groove of the thick portion, and thereby, the seal rip can be deflected at the annular groove. Thereby, it is possible to maintain a state in which the seal rip is pressed to the fuel supply piping.

A seventh aspect of the present invention is the fuel adapter structure according to the sixth aspect described above, wherein the seal lip may have a bent part.

According to this configuration, the seal lip has the bent part, and thereby, the seal rip can be deflected at the bent part. Thereby, it is possible to maintain a state in which the seal rip is pressed to the fuel supply piping.

An eighth aspect of the present invention is the fuel adapter structure according to any of the second to seventh aspects described above, wherein the outer seal part may have a lip shape and may be set to a length in which the outer seal part is in contact with the inner panel in a state where the outer panel and the inner panel are spaced most apart from each other.

According to this configuration, the outer seal part is formed in a lip shape, and the outer seal part is set to a length to be in contact with the inner panel in a state where the outer panel is spaced most apart from the inner panel. Accordingly, the opening edge can be sealed by the thick portion, and the inner panel can be sealed by the outer seal part. Thereby, the inner panel is reliably sealed by the inner panel-side seal part.

A ninth aspect of the present invention is the fuel adapter structure according to the fifth aspect described above, wherein the thick portion may be formed so as to overlap the opening edge in a state where the opening edge is varied and spaced apart in a direction that crosses with an axis line of the fuel adapter.

According to this configuration, it is possible to overlap the thick portion on the opening edge in a state where the opening edge is varied and spaced apart in the direction that crosses with the axis line of the fuel adapter. Accordingly, the thick portion can come into contact with a first opening edge that is varied relative to the axis line of the fuel adapter. Thereby, the thick portion can come into contact with the opening edge, and the opening edge can be sealed by the thick portion.

A tenth aspect of the present invention is the fuel adapter structure according to the fifth aspect described above, wherein the extraction portion may be an annular groove that opens at a front end of the thick portion and that is formed in an annular shape, and the inclination surface may be formed so as to overlap the annular groove in an axis line direction of the fuel adapter to the stopper portion.

According to this configuration, the inclination surface is formed so as to overlap the annular groove to the stopper portion. Accordingly, the inclination surface can be deformed to a predetermined deflection margin to the stopper portion. Thereby, the inclination surface can come into contact with the opening edge in accordance with the variation of the opening edge, and it is possible to suitably seal the opening edge by the inclination surface.

According to an aspect of the present invention, it is possible to absorb the variation of the relative position between the outer panel and the inner panel without stretching and contracting the fuel adapter, and furthermore, it is possible to enhance the assembly property.

### BRIEF DESCRIPTION OF THE DRAWINGS

FIG. 1 is a perspective view showing a state in which a fuel adapter structure is provided on a rear wheel house according to an embodiment of the present invention.

FIG. 2 is a cross-sectional view showing the fuel adapter structure according to the embodiment.

FIG. 3 is a perspective view of the fuel adapter structure when seen from an inside in a vehicle width direction according to the embodiment.

FIG. 4 is a perspective view showing a fuel adapter according to the embodiment.

FIG. 5 is a plan view seen from a direction of an arrow V of FIG. 4.

FIG. 6 is a perspective view showing a state in which the fuel adapter is disassembled from an inner panel according to the embodiment.

FIG. 7 is a perspective view showing an inner panel-side seal part according to the embodiment.

FIG. 8 is a cross-sectional view showing a state in which the inner panel is varied outward in the vehicle width direction according to the embodiment.

FIG. 9 is a cross-sectional view showing a state in which the inner panel is varied inward in the vehicle width direction according to the embodiment.

### DESCRIPTION OF EMBODIMENTS

Hereinafter, an embodiment of the present invention will be described with reference to the drawings. The embodiment is described, for convenience, using an example in which a fuel adapter structure 10 is provided on a left side part in a vehicle width direction in a vehicle; however, the embodiment is not limited thereto. In the drawings, an arrow FR indicates a frontward direction of the vehicle, an arrow UP indicates an upward direction of the vehicle, and an arrow LH indicates a leftward direction.

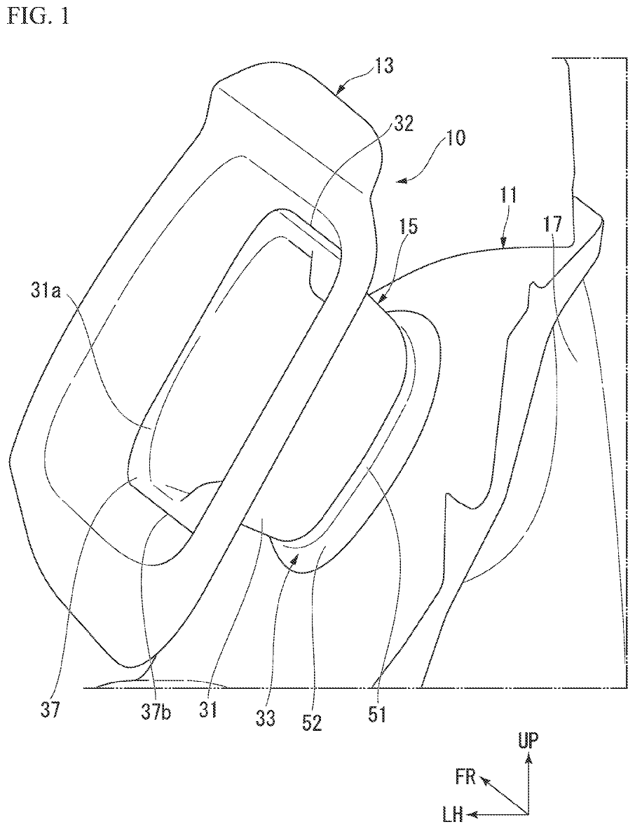

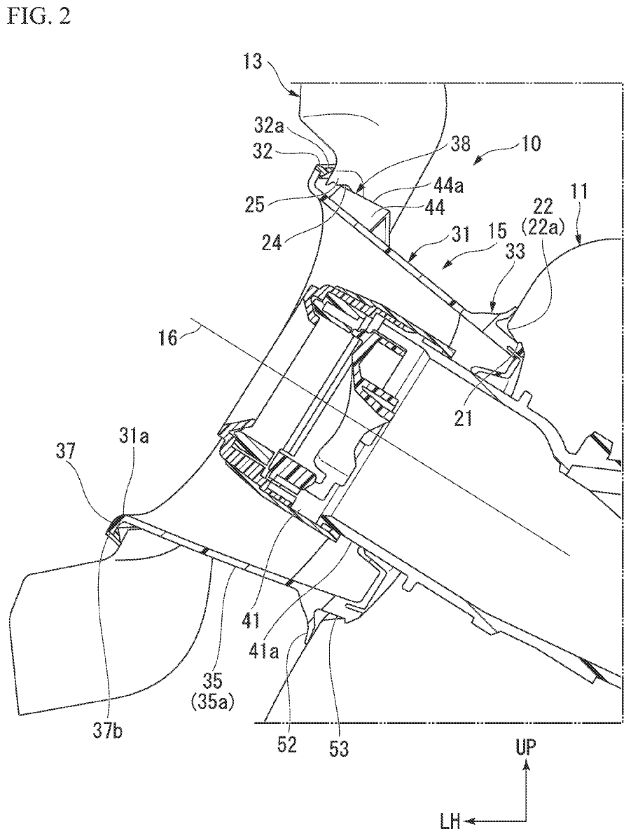

As shown in FIG. 1 and FIG. 2, the fuel adapter structure 10 includes an inner panel 11, an outer panel 13, and a fuel adapter 15.

The inner panel 11 is joined, for example, to a rear wheel house 17 from a vehicle outside.

The inner panel 11 has a first penetration hole (penetration hole) 21. The first penetration hole 21 is formed of a first opening edge (opening edge) 22. The first opening edge 22 has a tapered part 22a. The outer panel 13 is arranged to be spaced outward in the vehicle width direction from the inner panel 11 along an axis line 16 of the fuel adapter 15.

The axis line 16 of the fuel adapter 15 extends in an upward gradient toward the outside in the vehicle width direction. Hereinafter, the axis line 16 of the fuel adapter 15 may be abbreviated as an “axis line 16”. The outside in the vehicle width direction may be referred to as an “outside”, and the inside in the vehicle width direction may be referred to as an “inside”.

The outer panel 13 is an outside panel. The outer panel 13 has a second penetration hole 24. The second penetration hole 24 is formed of a second opening edge 25.

Here, the outer panel 13 and the inner panel 11 are assembled to a vehicle body. In this state, it is conceivable that due to tolerances of the outer panel 13 and the inner panel 11, a variation may occur in a relative position between the outer panel 13 and the inner panel 11, specifically in the axis line 16 (the vehicle width direction). Further, it is conceivable that a variation may occur in the first opening edge 22 in a direction that crosses with the axis line 16.

A fuel adapter 15 penetrates between the outer panel 13 and the inner panel 11.

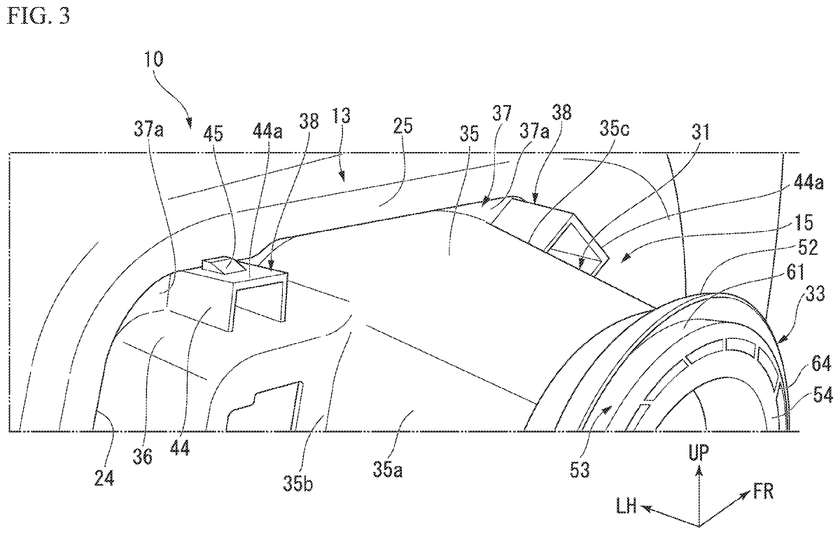

As shown in FIG. 2 to FIG. 4, the fuel adapter 15 includes an adapter main body 31, an outer panel-side seal part 32, and an inner panel-side seal part 33. In the fuel adapter 15, for example, the adapter main body 31, the outer panel-side seal part 32, and the inner panel-side seal part 33 are integrally formed by two-color molding. Materials of the adapter main body 31, the outer panel-side seal part 32, and the inner panel-side seal part 33 are described later in detail.

In the fuel adapter 15, as described above, the axis line 16 extends in an upward gradient toward the outside of the vehicle body. The adapter main body 31 is arranged between the outer panel 13 and the inner panel 11 and is formed of, for example, a rigid plastic such as polypropylene (PP). The adapter main body 31 includes an adapter cylinder part 35, an adapter expansion part 36, a flange part 37, and a plurality of lock parts 38.

The adapter cylinder part 35 is formed in a hollow cylindrical shape in which a fuel supply piping 41 is capable of being fitted. The adapter expansion part 36 is formed on a side wall 35a of the adapter cylinder part 35. The adapter expansion part 36 expands laterally from a region 35b of the side wall 35a of the adapter cylinder part 35, wherein the region 35b is located on an outside in the vehicle width direction in the axis line 16 direction and crosses (specifically, is orthogonal) in a vehicle body rearward direction (a horizontal direction) with the axis line 16.

In the adapter cylinder part 35 and the adapter expansion part 36, a flange part 37 is formed on an outer end part in the vehicle width direction in the axis line 16 direction. The flange part 37 expands in a direction that crosses with the axis line 16 and toward a direction that is apart from the axis line 16. The flange part 37 is formed in a substantially rectangular outer shape.

A lock part 38 is formed in a formation region 35c of the side wall 35a of the adapter cylinder part 35, wherein the formation region 35c is adjacent to and circumferentially spaced from a corner portion 37a of the flange part 37. Further, a lock part 38 is formed in a formation region 36b of the side wall 36a of the adapter expansion part 36, wherein the formation region 36b is adjacent to and circumferentially spaced from the corner portion 37a of the flange part 37.

For example, four lock parts 38 are shown in the embodiment, but the number of the lock parts 38 is not limited thereto.

The lock part 38 has a base 44 and a lock claw 45. The base 44 is provided in the formation region 35c of the adapter cylinder part 35 and the formation region 36b of the adapter expansion part 36 and is provided on the corner portion 37a of the flange part 37 or in the vicinity of the corner portion 37a. A lock claw 45 is formed on a support surface 44a of the base 44.

The lock claw 45 is locked to the second opening edge 25 from an inside in a state where the second opening edge 25 of the outer panel 13 (specifically, the second penetration hole 24) is in contact with the support surface 44a of the base 44.

The outer panel-side seal part 32 is formed in an annular manner on an outer circumferential edge 37b of the flange part 37. The outer panel-side seal part 32 is formed of, for example, a flexible plastic such as an olefinic thermoplastic elastomer (TPO) to be elastically deformable integrally with the adapter main body 31 by two-color molding. The outer panel-side seal part 32 has an outer lip part 32a that comes into contact with the second opening edge 25 of the outer panel 13 (specifically, the second penetration hole 24) from the outside.

The lock claw 45 is locked to the second opening edge 25 from the inside in a state where the outer lip part 32a is in contact with the second opening edge 25 from the outside, and thereby, an outer end part 31a of the adapter main body 31 is supported by the outer panel 13.

Further, the inner panel-side seal part 33 is integrally formed on an inner end edge 31b of the adapter main body 31. The inner panel-side seal part 33 is formed of, for example, a flexible plastic such as an olefinic thermoplastic elastomer (TPO) to be elastically deformable integrally with the inner end edge 31b by two-color molding.

That is, the inner panel-side seal part 33 is formed to be capable of being deflected and deformed so as to absorb the variation of the relative position between the outer panel 13 and the inner panel 11. The inner panel-side seal part 33 is in contact with the first opening edge 22 of the inner panel 11 (specifically, the first penetration hole 21) in a pressed manner.

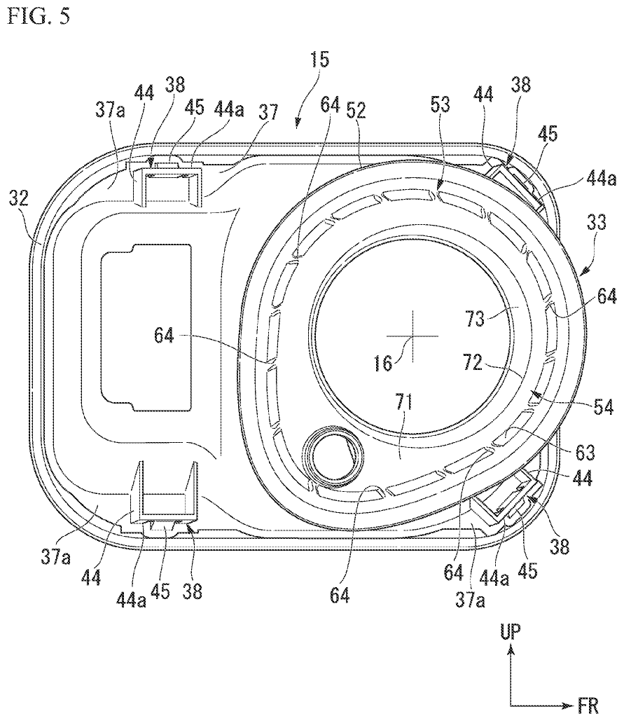

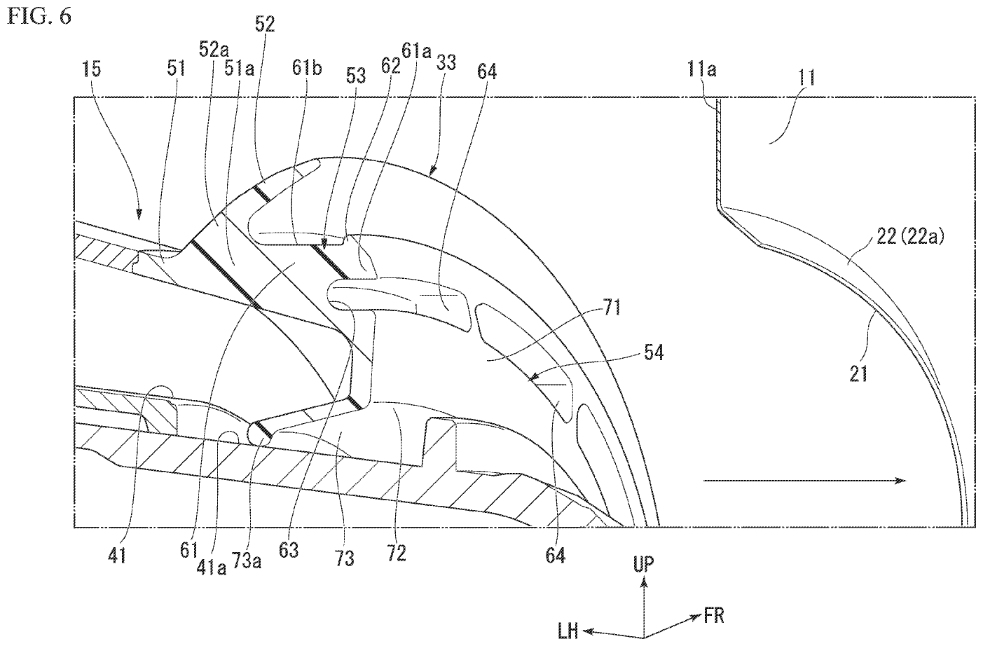

As shown in FIG. 5 and FIG. 6, the inner panel-side seal part 33 includes a seal base portion 51, an outer seal portion 52, an inner seal portion 53, and a connection portion 54 that includes a pipe-side seal 73.

The seal base portion 51 is annularly formed integrally along the inner end edge 31b of the adapter main body 31. An outer seal portion 52 is annularly formed along an outer circumferential surface of the seal base portion 51. The outer seal portion 52 extends in a lip shape so as to be in contact with an outer surface 11a of the inner panel 11 and is formed to be elastically deformable.

The outer seal portion 52 extends in a lip shape, and thereby, a state is maintained in which the outer seal portion 52 is in contact with the outer surface 11a of the inner panel 11 in accordance with the variation in the axis line 16 (refer to FIG. 2) direction of the inner panel 11. In other words, the outer seal portion 52 is set to a length in which the outer seal part 52 is in contact with the inner panel 11 even in a state where the outer panel 13 and the inner panel 11 are spaced most apart from each other. Thereby, the inner panel 11 is sealed by the outer seal portion 52.

Further, the inner seal part 53 is formed integrally on an inner end section 51a of the seal base portion 51 and a base section 52a of the outer seal portion 52. The inner seal part 53 extends so as to penetrate through the first penetration hole 21 of the inner panel 11 from the outside to the inside (also refer to FIG. 2).

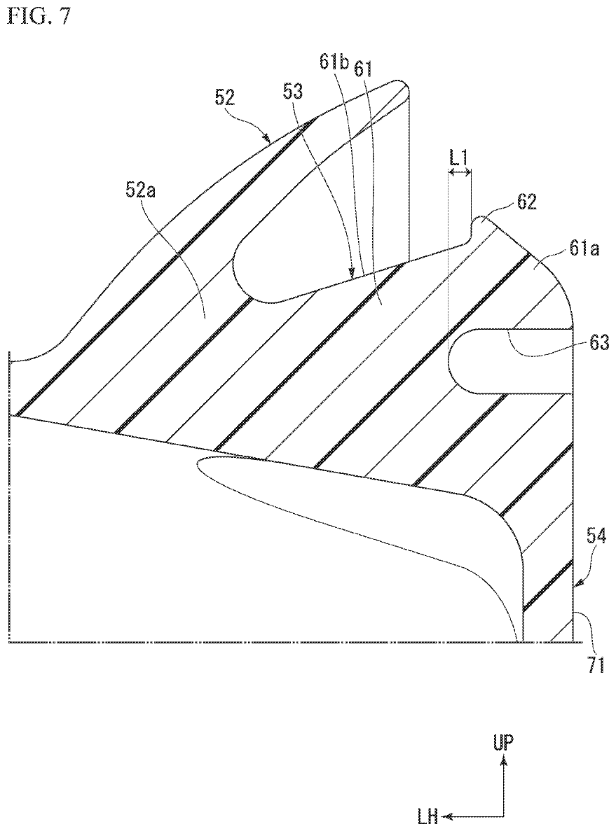

As shown in FIG. 6 and FIG. 7, the inner seal part 53 includes a thick portion 61, a stopper portion 62, an extraction portion 63, and an anti-deflection rib 64.

The thick portion 61 has an outer circumferential surface 61b that is formed between the base section 52a of the outer seal portion 52 and an inner end section (front end section) 61a (the stopper portion 62 described later). The outer circumferential surface 61b is formed so as to be inclined inward from the base section 52a of the outer seal portion 52 and toward the tapered part 22a of the outer panel 13. Hereinafter, the outer circumferential surface 61b is described as an “inclination surface 61b”.

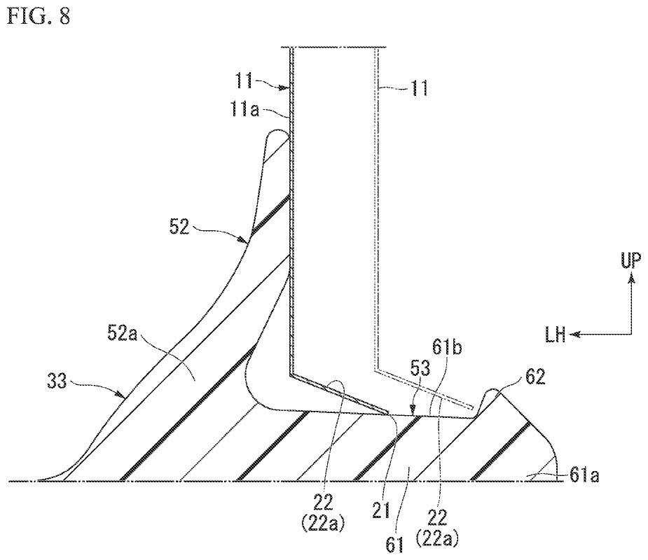

That is, the inclination surface 61b is formed in an inclined manner from the base section 52a of the outer seal portion 52 toward the stopper portion 62 in a direction that is apart from the axis line 16 (refer to FIG. 2). Accordingly, the thick portion 61 is formed such that the thickness gradually increases from the outside of the inner panel 11 via the first penetration hole 21 toward the inner end section 61a (that is, the stopper portion 62). The thick portion 61 extends so as to penetrate through the first penetration hole 21 of the inner panel from the outside to the inside. Accordingly, the inclination surface 61b of the thick portion 61 is pressed to the first opening edge 22 of the first penetration hole 21 (refer to FIG. 2 and FIG. 8).

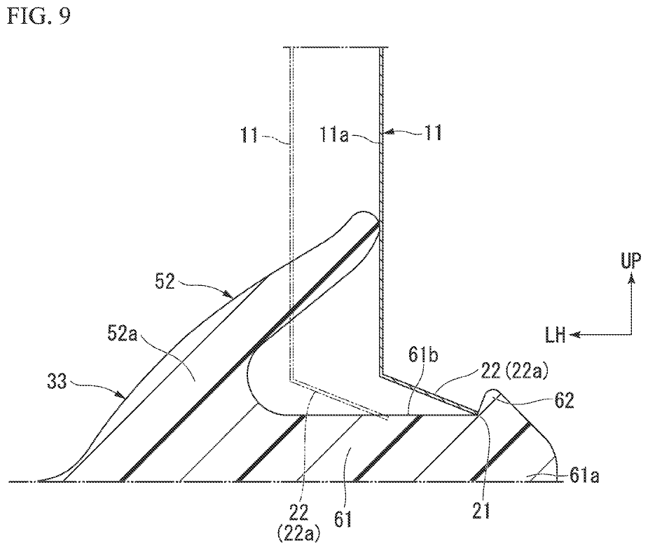

As shown in FIG. 8 and FIG. 9, it is conceivable that the first opening edge 22 of the inner panel 11 (that is, the first penetration hole 21) is varied and spaced apart in a direction that crosses with the axis line 16 (refer to FIG. 2) of the fuel adapter 15. In FIG. 8, the inner panel 11 indicated by a solid line shows a state in which the inner panel 11 is varied to an outermost side in the vehicle width direction, and the inner panel 11 indicated by an imaginary line shows a state in which the inner panel 11 is varied to an innermost side in the vehicle width direction. In FIG. 9, the inner panel 11 indicated by a solid line shows a state in which the inner panel 11 is varied to an innermost side in the vehicle width direction, and the inner panel 11 indicated by an imaginary line shows a state in which the inner panel 11 is varied to an outermost side in the vehicle width direction.

In this state, the thick portion 61 is formed to overlap (lap) with the first opening edge 22. Accordingly, the thick portion 61 (specifically, the inclination surface 61b) can be in contact with the first opening edge 22 that is varied in a direction that crosses with the axis line 16 of the fuel adapter 15. Further, by forming the thick portion 61 so as to overlap the first opening edge 22, the thick portion 61 can be in contact with the first opening edge 22 in accordance with the variation of the relative position in the axis line 16 direction between the outer panel 13 and the inner panel 11. Thereby, it is possible to seal the first opening edge 22 by the thick portion 61.

Further, the stopper portion 62 is formed integrally on the inner end section 61a (inner end part of the inclination surface 61b) of the thick portion 61. That is, the stopper portion 62 is arranged inside the inner panel 11. The stopper portion 62 is projected from the inner end part of the inclination surface 61b in a direction that crosses with the axis line 16 of the fuel adapter 15 and in a direction apart from the axis line 16.

Thereby, the stopper portion 62 is in contact with the first opening edge 22 and prevents the thick portion 61 from exiting the first penetration hole 21.

As shown in FIG. 6 and FIG. 7, the extraction portion 63 is formed on an inner end section (the inner end section 61a of the thick portion 61) of the inner seal part 53. The extraction portion 63 opens at the inner end section 61a of the thick portion 61 and is formed in a U shape in a cross-section. The extraction portion 63 is an annular groove that is formed annularly along the inner end section 61a of the thick portion 61. Hereinafter, the extraction portion 63 is described as an “annular groove 63”.

Here, the inclination surface 61b of the thick portion 61 is formed in an overlapping state so as to overlap with the annular groove 63 in a range L1 to the stopper portion 62 in the axis line 16 (refer to FIG. 2) direction. Accordingly, the inclination surface 61b can be deflected and deformed in a range of a predetermined deflection margin.

Further, the thick portion 61 extends so as to penetrate through the first penetration hole 21 of the inner panel from the outside to the inside. Accordingly, the inclination surface 61b of the thick portion 61 is pressed to the first opening edge 22 of the first penetration hole 21.

Thereby, the variation in the direction that crosses with the axis line 16 (refer to FIG. 2) of the first opening edge 22 of the inner panel 11 can be absorbed by the deflection deformation of the thick portion 61. Further, the variation of the relative position in the axis line 16 direction between the outer panel 13 and the inner panel 11 can be absorbed by the deflection deformation of the thick portion 61. In this way, the inclination surface 61b of the thick portion 61 can be pressed to (be in contact with) the first opening edge 22 in accordance with the variation of the first opening edge 22, and the first opening edge 22 can be reliably sealed by the thick portion 61.

Hereinafter, the variation of the relative position in the axis line 16 direction between the outer panel 13 and the inner panel 11 may be also referred to as a “variation in the axis line 16 direction of the first opening edge 22”.

Further, the extraction portion 63 is the annular groove 63, and thereby, the thick portion 61 can be deflected and deformed along the entire circumference of the first opening edge 22 of the first penetration hole 21. That is, the thick portion 61 can be deflected and deformed in a direction that crosses with the axis line 16.

Accordingly, the variation in the direction that crosses with the axis line 16 (refer to FIG. 2) of the first opening edge 22 and the variation in the direction of the axis line 16 of the first opening edge 22 can be absorbed at the entire circumference of the first opening edge 22. Thereby, the entire circumference of the first opening edge 22 can be suitably sealed by the inclination surface 61b.

As shown in FIG. 8 and FIG. 9, the tapered part 22a of the first opening edge 22 formed on the inner panel 11 is inclined toward an inside of the inner panel 11 and toward the thick portion 61 (the axis line 16 (refer to FIG. 2)). That is, the tapered part 22a of the first opening edge 22 and the inclination surface 61b of the thick portion 61 are inclined in a direction that crosses with each other.

Accordingly, the inclination surface 61b of the thick portion 61 can be suitably adapted to the variation in the direction of the axis line 16 according to the tapered part 22a of the first opening edge 22 and the direction that crosses with the axis line 16. That is, the variation of the tapered part 22a can be suitably absorbed by the inclination surface 61b of the thick portion 61. Thereby, the inclination surface 61b can reliably come into contact with the tapered part 22a having the variation, and both reliable assembly of the fuel adapter 15 and sealing of the first opening edge 22 (that is, the first penetration hole 21) are enabled.

Here, the outer seal portion 52 is in contact with the outer surface 11a of the inner panel 11, and thereby, the outer surface 11a of the inner panel 11 is sealed by the outer seal portion 52. Further, the first opening edge 22 of the inner panel 11 is sealed by the thick portion 61. Thereby, the inner panel 11 is reliably sealed by the inner panel-side seal part 33.

As shown in FIG. 5 and FIG. 6, a plurality of anti-deflection ribs 64 are formed in an inside of the annular groove 63. The plurality of anti-blocking ribs 64 are formed at intervals in a circumferential direction in the inside of the annular groove 63. The anti-deflection rib 64 is formed to be directed in a direction that crosses obliquely with a deflection direction (for example, a direction perpendicular to a tangent line of the thick portion 61) of the thick portion 61.

In this way, the plurality of anti-deflection ribs 64 are formed at intervals in the circumferential direction in the inside of the annular groove 63. Thereby, it is possible to prevent the thick portion 61 from being deflected to an opposite side of the annular groove 63 in a state where the inclination surface 61b of the thick portion 61 is in contact with the first opening edge 22 (refer to FIG. 8 and FIG. 9).

Further, the plurality of anti-deflection ribs 64 are formed at intervals in the circumferential direction along the annular groove 63 and are formed to be directed in a direction that crosses obliquely with the deflection direction of the extraction portion 63. Thereby, it is possible to suitably deflect and deform the thick portion 61 without blocking the deflection deformation of the thick portion 61 by the anti-deflection rib 64.

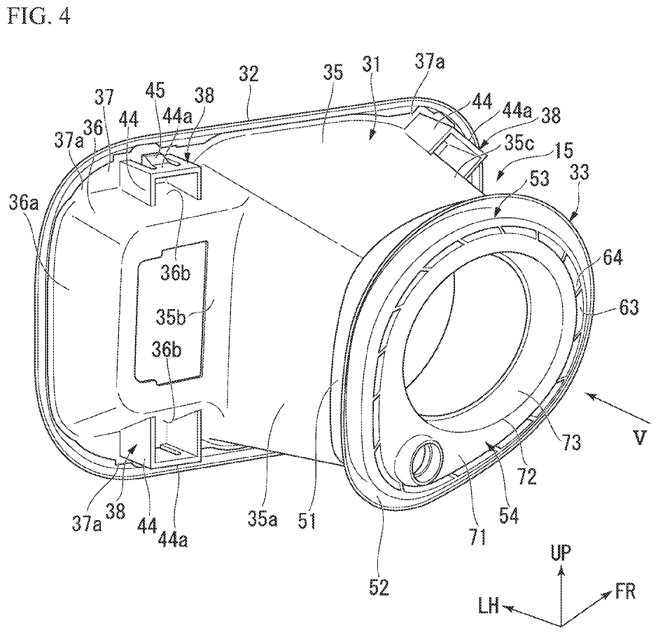

As shown in FIG. 4 and FIG. 6, the connection part 54 is formed integrally in a region of the inner end section 61a of the thick portion 61, the region being on the axis line 16 side of the annular groove 63. The connection part 54 is provided to extend from the region on the axis line 16 side of the annular groove 63 so as to be in contact with the fuel supply piping 41 and includes a function as a seal lip.

Specifically, the connection part 54 (seal lip) includes a connection portion 71, a bent portion 72, and a pipe-side seal 73. The connection portion 71 projects annularly toward the fuel supply piping 41 from the region on the axis line 16 side of the annular groove 63 of the inner end section 61a of the thick portion 61.

The pipe-side seal 73 projects in an annular shape inclined toward the fuel supply piping 41 and outward from the bent portion 72. The bent portion 72 is formed of the connection portion 71 and the pipe-side seal 73 in a V shape in a cross-section. In the pipe-side seal 73, the front end part 73a is in contact with the outer circumferential surface 41a of the fuel supply piping 41 in a state of pressing the outer circumferential surface 41a of the fuel supply piping 41.

In this way, the connection part 54 is provided to extend from the annular groove 63 of the thick portion 61 of the inner end section 61a of the thick portion 61, and thereby, the connection part 54 can be deflected using the deflection deformation of the annular groove 63. Thereby, it is possible to maintain a state in which the connection part 54 is pressed to the fuel supply piping 41.

Further, the connection part 54 has the bent portion 72, and thereby, the connection part 54 can be deflected by bending the bent portion 72. Thereby, it is possible to maintain a state in which the connection part 54 is pressed to the fuel supply piping 41.

As described above, according to the fuel adapter structure 10, the adapter main body 31 is formed of a rigid plastic. Further, the outer panel-side seal part 32 is formed of a flexible plastic to be elastically deformable. The outer panel-side seal part 32 is in contact with the outer panel 13 from the outside. Further, the lock part 38 of the adapter main body 31 is locked to the outer panel from the inside.

Additionally, the inner panel-side seal part 33 is formed of a flexible plastic to be elastically deformable, and the inner panel-side seal part 33 is formed to be capable of being deflected and deformed. Accordingly, the variation in the direction that crosses with the axis line 16 (refer to FIG. 2) of the first opening edge 22 and the variation in the direction of the axis line 16 of the first opening edge 22 can be absorbed by the inner panel-side seal part 33.

Thereby, it is possible to deflect the inner panel-side seal part 33 by pushing the fuel adapter 15 to the inside from the outside of the outer panel 13. Accordingly, it is possible to absorb the variation in a direction that crosses with the axis line 16 of the first opening edge 22 and the variation in the direction of the axis line 16 of the first opening edge 22 without stretching or contracting the fuel adapter 15.

Accordingly, the outer panel-side seal part 32 can be pressed to the outer panel 13, and the inner panel-side seal part 33 can be pressed to the inner panel 11. As a result, it is possible to ensure that a space between the outer panel 13 and the inner panel 11 is in a sealed state by the fuel adapter 15 only by pushing the fuel adapter 15, and it is possible to enhance the assembly property of the fuel adapter structure 10.

Although a preferred embodiment of the present invention has been described, the present invention is not limited to such an embodiment. Additions, omissions, substitutions, and other modifications of the configuration can be made without departing from the scope of the present invention, and the modifications described above can be suitably combined.

For example, the embodiment is described using an example in which the extraction portion 63 is an annular groove; however, the embodiment is not limited thereto. As another example, the extraction portion 63 may be formed in a hollow shape.

What is claimed is:

1. A fuel adapter structure, comprising
a fuel adapter that penetrates between an outer panel and an inner panel,
wherein the fuel adapter includes:
an adapter main body that is arranged between the outer panel and the inner panel and that is formed of a rigid plastic;
an outer panel-side seal part that is formed of a flexible plastic to be elastically deformable on the adapter main body and that is in contact with the outer panel from an outside; and
an inner panel-side seal part that is formed of a flexible plastic to be elastically deformable on the adapter main body and that is in contact with the inner panel,
the adapter main body includes a lock part that is locked to the outer panel from an inside, and
the inner panel-side seal part is capable of being subject to a deflection deformation that absorbs a variation of a relative position between the outer panel and the inner panel.

2. The fuel adapter structure according to claim 1,
wherein the inner panel-side seal part includes:
an outer seal part that is in contact with an outer surface of the inner panel; and
an inner seal part that penetrates through the inner panel, and
the inner seal part includes:
a stopper portion that is arranged on an inside of the inner panel;
a thick portion of which a thickness gradually increases from an outside of the inner panel toward the stopper portion; and
an extraction portion that enables the deflection deformation by the thick portion.

3. The fuel adapter structure according to claim 2,
wherein the inner seal part has an anti-deflection rib which is formed in an inside of the extraction portion to be directed in a direction that crosses obliquely with a deflection direction of the extraction portion so as to prevent the inner seal part from being deflected to an opposite side of the extraction portion.

4. The fuel adapter structure according to claim 2,
wherein the extraction portion is an annular groove that opens at a front end of the thick portion and that is formed in an annular shape.

5. The fuel adapter structure according to claim 2,
wherein the inner panel includes a penetration hole through which the inner seal part penetrates,
an opening edge of the penetration hole includes a tapered part that is inclined toward an inside of the inner panel and toward the thick portion, and
the thick portion includes an inclination surface that is inclined toward an inside of the inner panel and toward the tapered part.

6. The fuel adapter structure according to claim 4,
wherein the inner panel-side seal part has a seal rip that is provided to extend from the annular groove of the thick portion so as to be in contact with a fuel supply piping.

7. The fuel adapter structure according to claim 6,
wherein the seal lip has a bent part.

8. The fuel adapter structure according to claim 2,
wherein the outer seal part has a lip shape and is set to a length in which the outer seal part is in contact with the inner panel in a state where the outer panel and the inner panel are spaced most apart from each other.

9. The fuel adapter structure according to claim 5,
wherein the thick portion is formed so as to overlap the opening edge in a state where the opening edge is varied and spaced apart in a direction that crosses with an axis line of the fuel adapter.

10. The fuel adapter structure according to claim 5,
wherein the extraction portion is an annular groove that opens at a front end of the thick portion and that is formed in an annular shape, and
the inclination surface is formed so as to overlap the annular groove in an axis line direction of the fuel adapter to the stopper portion.
